(19) United States
(12) Patent Application Publication
(10) Pub. No.: US 2020/0299462 A1
(43) Pub. Date: Sep. 24, 2020

(54) METHOD FOR PREPARING ULTRAVIOLET (UV) CURING POLYMETHYL SILOXANE CONTAINING ACRYLATE STRUCTURE

(71) Applicant: CHANGZHOU UNIVERSITY, Changzhou, Jiangsu (CN)

(72) Inventors: Xiaoqiang XUE, Changzhou, Jiangsu (CN); Bibiao JIANG, Changzhou, Jiangsu (CN); Wenyan HUANG, Changzhou, Jiangsu (CN); Hongjun YANG, Changzhou, Jiangsu (CN); Qimin JIANG, Changzhou, Jiangsu (CN); Jiayue SUN, Changzhou, Jiangsu (CN)

(21) Appl. No.: 16/770,355

(22) PCT Filed: Feb. 27, 2019
(86) PCT No.: PCT/CN2019/076331

§ 371 Date: Jun. 5, 2020

(30) Foreign Application Priority Data
Apr. 27, 2018 (CN) 201810390608.8
Apr. 27, 2018 (CN) 201810390616.2
Apr. 27, 2018 (CN) 201810390617.7
Apr. 27, 2018 (CN) 201810390687.2

(51) Int. Cl. C08G 77/38; C08J 7/04

(52) U.S. Cl. CPC C08G 77/38; C08J 2367/02; C08J 7/0427

(57) ABSTRACT

The present invention relates to a method for preparing an ultraviolet (UV) curing polymethyl siloxane containing an acrylate structure: performing a Michael addition reaction with an amino silicone oil by means of an asymmetric diene acrylate ethylene glycol methacrylate, the double bond of asymmetric diene having a large difference in activity, and the acrylate structure preferentially undergoing addition with an amino group; thus, a methacrylic structure is successfully linked to a side chain of the methyl silicone oil, and a methyl silicone oil having a controllable structure and having a side group containing the methacrylate structure is prepared, the reaction having a high grafting rate; the described method is a high-efficiency, mild and controllable preparation method; a conventional compound photoinitiator is selected, and is coated on a substrate for UV curing, quickly curing at room temperature to form a film, and having the features of being clean and pollution-free.

### TECHNICAL FIELD

The present invention belongs to the field of high polymer material science, and particularly relates to a method for preparing an ultraviolet (UV) curing methyl silicone oil.

### BACKGROUND

Polymethyl siloxane, namely, methyl silicone oil, has many excellent physical and chemical properties due to a unique chemical structure, the structure takes a silicon-oxygen bond as a main chain, and has the characteristic of wonderful mild structure, meanwhile, shows high temperature resistance and low temperature resistance, and can be used in a wider temperature scope, moreover, compared with conventional polymers, a silicon-oxygen structure has excellent properties of weather resistance, corrosion resistance, electric insulativity, ozone resistance, waterproofness, flame retardance, physiological inertia and the like, and polymethyl siloxane is widely applied in various industries such as national economy, such as aerospace, daily materials, electronics and electrics, chemical machinery, medical treatment and public health, and transportation.

Currently, conventional organosilicone is formed by curing with a high-performance catalyst at high temperature, as a result, not only is curing speed low, energy consumption high, and curing efficiency low, but also volatilization of solvent and low molecular weight organic matters is generated in a curing process, which will pollute the environment, and residue of metal catalyst affects the product property and application points, therefore, it limits the application and popularization of organosilicone to a great extent.

Ultraviolet light (UV) is a kind of new energy-saving and environment-friendly technology, has the advantages of being rapid in curing (forming a film in several seconds), and uniform in curing, implementing curing at room temperature, and being energy-saving and efficient, and environment-friendly, and is especially applicable to a forming method of thermal sensitive components, local copying and photoetching of semiconductor circuits, therefore, photocuring is a very promising curing method. Therefore, many advantages of being high-efficiency and rapid in curing and forming, clean and environment-friendly and energy-saving are shown by introducing a silicon-oxygen main chain into a functional group available for ultraviolet curing and performing cross-linking and curing under irradiation of ultraviolet light, and the obtained material has the advantages of temperature resistance, weather resistance, electric insulation, low surface tension and low surface energy and the like, consequently, a methyl silicone oil material containing an acrylics functional group has an organosilicone polymer with ultraviolet activity, is generally higher in photopolymerization activity and faster in reaction rate, has a certain antioxidant polymerization capacity, and with low cost, becomes a prepolymer with the maximal use amount in existing ultraviolet curing products, and thus can be applied to rapid streamlined manufacture of release films of different base materials; and the methyl silicon material not only reserves advantages of organosilicone after curing, but also has the film-forming property, good color retention, high luster, and excellent adhesive property of acrylate, thereby promoting the application and popularization of organosilicone, such as industries of coatings, paint, leather auxiliaries and packaging.

Earlier acrylate modified methyl silicone oil is prepared by the hydrolytic condensation reaction of dichlorosilane and hydroxyethyl acrylate (HEA) in polymethyl siloxane under alkali catalysis, however, this modified polysiloxane contains an Si—O—C bond sensitive to humidity, and is poor in hydrolytic stability, and an HEA structure is easily inactivated due to dissociation, therefore, it is necessary to synthesize high-stability acrylate polymethyl siloxane of an Si—C structure, main synthesis methods including a hydrosilylation method, an esterification method and a dealcoholization method. Polymethyl siloxane containing silicon-hydrogen groups directly performs hydrosilylation reaction (Oestreich S, Struck S. MacromolSymp., 2002, 187(1), 333.) with symmetric diacrylate, and acrylate polysiloxane is obtained under the catalysis of H₂PtO₆6H₂O; because diacrylate has same activity, cross-linking reaction between polymer chains may occur in an addition reaction process, and influences are great, moreover, catalysts are relatively expensive, as a result, application and popularization of the reaction are limited. Acrylate polysiloxane (Carter G R, Watson S L, Pines A N, U.S. Pat. No. 4,293,678, 1981.) is prepared by adopting an esterification method by utilizing epoxy-terminated polymethyl siloxane and acrylic acid under the catalysis of a catalyst; hydroxyalkyl-terminated polymethyl siloxane generates esterification reaction with acrylic acid to obtain acrylate polysiloxane (Hockemeyer F, Preiner G U.S. Pat. No. 4,554,339, 1985.); He Hua et al. synthesized acrylate polysiloxane by reaction of chloropropyl polysiloxane and hydroxypropyl acrylate, to be taken as an insulator to research ultraviolet curing characteristics and anti-adhesion property thereof (He Hua, Tao Yongjie, Li Bing, Adhesion, 2005, 26(6), 7). The activity of esterification reaction limits that the esterification efficiency is relatively low, and the grafting rate of acrylate affects the application of organosilicone.

Along with the development of science and technology, the requirements of people for a rapid curing system of polymethyl siloxane is wider and wider, and polymethyl siloxane plays a very important role in the industries such as aerospace, daily materials, electronics and electrics, chemical machinery, medical treatment and public health, and transportation, and can greatly save time, increase process efficiency and promote product quality, therefore, popularization of UV cured polymethyl siloxane is effectively promoted by promoting the grafting efficiency of acrylate and lowering preparation cost.

### SUMMARY

The present invention is directed to provide methacrylate-based polymethyl siloxane with excellent properties, high grafting rate and low cost, solving the technical problems of the prior art that catalysts are expensive, cross-linking easily occurs in a reaction process, acrylate grafting efficiency is low, and preparation of a photoinitiator in a curing process is complicated and expensive. The obtained methacrylate-based polymethyl siloxane has the advantage that preparation is simple, preparation cost is low, use is convenient, acrylate grafting rate is high, activity is high, the preparation method is high-efficiency, mild and controllable, ultraviolet curing and forming time is short, complicated preparation of a silicone oil-modified photoinitiator is not needed, a commercially available compound photoinitiator with low cost is adopted, and a cured organosilicone material has the advantages of high temperature resistance, good weather resistance, good electrical insulation and low surface tension, and can be widely applied in the industries such as release coating, coating, leather additives and packaging.

The present invention adopts the following technical scheme:

An ultraviolet (UV) curing polymethyl siloxane (PSi-MA) containing an acrylate structure, with a general structural formula of [1] or [2]:

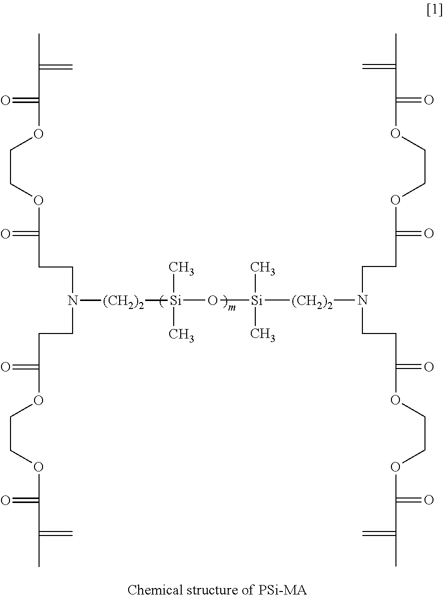

In formula [1], m=15-200, molecular weight being 1700˜15700, wherein m is an integer.

The PSi-MA is prepared by performing a Michael addition reaction and purifying with an amino silicone oil by means of prepared asymmetric diene acrylate ethylene glycol methacrylate, a reaction equation being [1]:

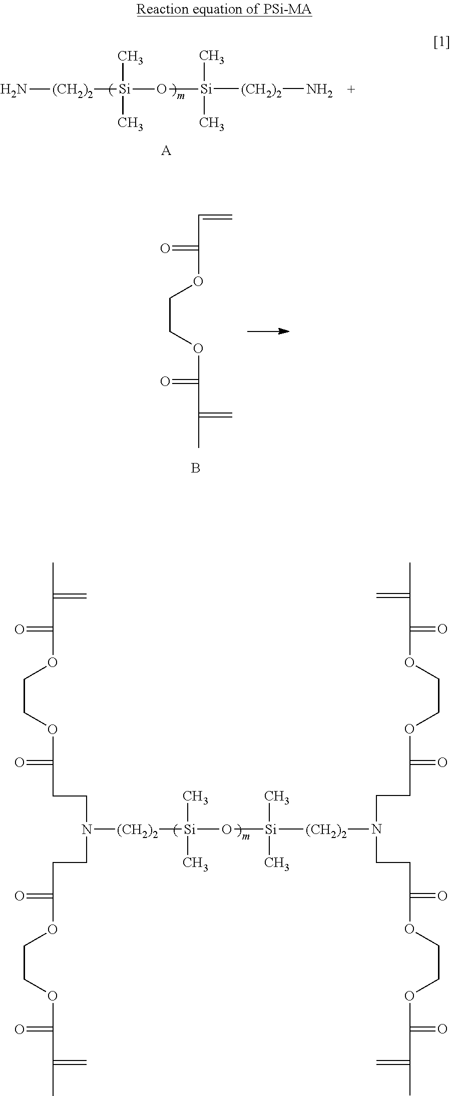

The raw material A is amino-terminated silicone oil, self-made, and m in the structure may be any integer, and may be set as m=15-200, molecular weight being 1000˜15000.

Or a general structural formula of [2]

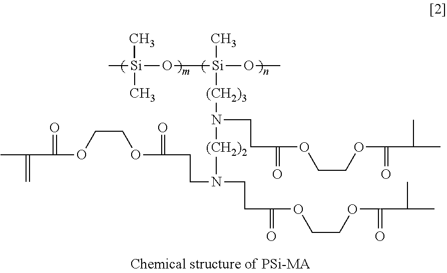

In formula [2], m=15-200, molecular weight being 1700˜15700, wherein m is an integer.

The PSi-MA is prepared by performing a Michael addition reaction and purifying with an amino silicone oil by means of prepared asymmetric diene acrylate ethylene glycol methacrylate, a reaction equation being [2]:

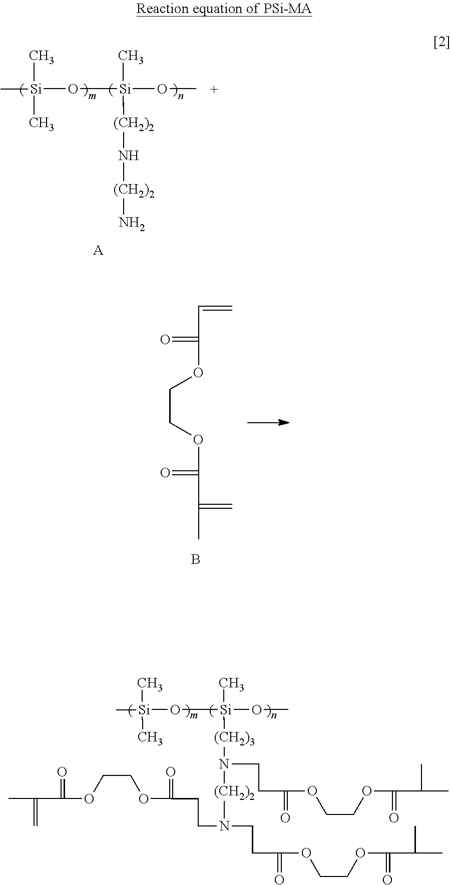

The raw material A is amino silicone oil, self-made, and m in the structure may be any integer, and may be set as m=15-200, molecular weight being 1000˜15000.

The raw material B is of an asymmetric diene structure, which is glycol methacrylate, self-made, and the purpose of such design is that activity of addition reaction of an acrylate structure and amino is far higher than the reaction activity of a methacrylate structure in the Michael addition reaction, therefore, the methacrylate structure after the addition reaction enters the terminal of polymethyl siloxane is relatively steady, so as to avoid branching, even cross-linking side reaction, caused by further addition between chains with an amino structure of a polymer, and free acrylate micromolecules preferentially perform addition reaction with residual amino structure in the polymer, as a result, reaction can be thoroughly performed just by adding B of same molar groups, without adding excessive B, so that controllability of reaction is promoted; meanwhile, the activity of the Michael addition reaction is higher, the grafting rate of methacrylate is up to more than 95%, and reaction has good controllability and reaction mildness.

Conditions for the Michael addition reaction are: room temperature, good solvents such as tetrahydrofuran, ethyl acetate, methylbenzene, dimethylbenzene and butanone being available as a solvent, reaction time being just 5 hours, reduced pressure rotary evaporation for postreatment, the solvent being recyclable, and the whole technological process being simple and controllable.

The polymethyl siloxane material (PSi-MA) having an end group containing a methacrylate structure has extremely high methacrylate grafting rate, which reaches more than 95%. With existence of a photoinitiator, the polymethyl siloxane material is rapidly cured and formed by ultraviolet (UV) irradiation at normal temperature, or is coated to a film to form a film, curing time being 1-5 seconds; the photocuring reaction has the advantages of being rapid in curing, and uniform in curing, implementing curing at room temperature, and being energy-saving and efficient, and environment-friendly; a prepared organosilicone film material has the advantages of high temperature resistance, good weather resistance, good electrical insulation, low surface tension and so on, and can be widely applied in the industries such as release coating, coating, leather additives and packaging.

The photoinitiator is a conventional commercially available initiator, and is good in compatibility with PSi-MA, further, photo-initiation activity and efficiency are promoted by a compound photoinitiator, without the need of complicated preparation of a silicone oil-modified photoinitiator, therefore, a preparation method is greatly simplified, and product preparation cost is lowered, conventional photoinitiator being: free radical like type photoinitiators such as 1-hydroxycyclohexyl phenyl ketone (184), 2-hydroxyl-4′-(2-hydroxylethoxy)-2-methylpropiophenone, 2,4,6(trimethyl benzoyl)diphenylphosphine oxide, 2,4,6-ethyl trimethyl benzoyl phosphonate, 2-isopropylthioxanthone and 4-dimethylamino-ethyl benzoate, and two or more than two of the foregoing photoinitiators are compounded to prepare a high-efficiency organosilicone photoinitiator.

The polymethyl siloxane material containing the methacrylate structure forms a film by ultraviolet curing to obtain a release film, which has excellent low surface energy and an excellent release effect: residual adhesion rate of a standard adhesive tape is up to 93%, and release force is stabilized at about 9.5 Win, therefore, the present invention is a rapid organosilicone photocuring system without solvent or metal catalyst and with no requirement for high temperature curing.

### BRIEF DESCRIPTION OF THE DRAWINGS

FIG. 1 is a nuclear magnetic map of asymmetric diene acrylate ethylene glycol methacrylate;

FIG. 2 is a nuclear magnetic map of amino silicone oil of embodiment 1;

FIG. 3 is a nuclear magnetic map of a polymethyl siloxane material (PSi-MA) containing an acrylate structure of embodiment 1;

FIG. 4 is an infrared comparison diagram of amino silicone oil and a polymethyl siloxane material (PSi-MA) containing an acrylate-terminated structure of reaction formula [1];

FIG. 5 is a contact angle test chart of ultraviolet curing film forming of polymethyl siloxane containing an acrylate structure on a PET base material (A: silicone oil curing film, B: PET film) of embodiment 5;

FIG. 6 is a nuclear magnetic map of amino silicone oil in embodiment 9;

FIG. 7 is a nuclear magnetic map of a polymethyl siloxane material (PSi-MA) having a side group containing the methacrylate structure obtained in embodiment 9;

FIG. 8 is an infrared comparison diagram of amino silicone oil and a polymethyl siloxane material (PSi-MA) having a side group containing the methacrylate structure of reaction formula [2]; and

FIG. 9 is a contact angle test chart of ultraviolet curing film forming of polymethyl siloxane containing a methacrylate structure on a PET base material (A: PET film, B: silicone oil curing film) of embodiment 13.

### DESCRIPTION OF THE EMBODIMENTS

The following further describes the present invention with reference to embodiments:

### Embodiment 1

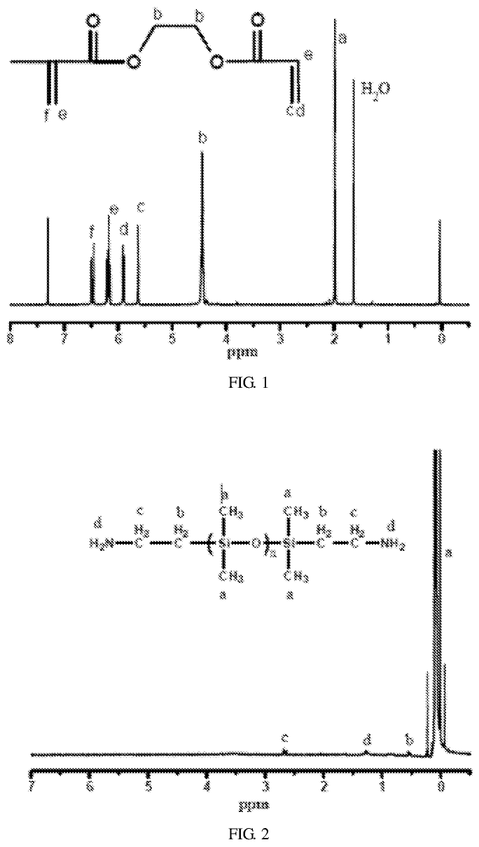

Synthesis of a polymethyl siloxane material (PSi-MA) containing an acrylate-terminated structure. A synthesis reaction formula [1] being:

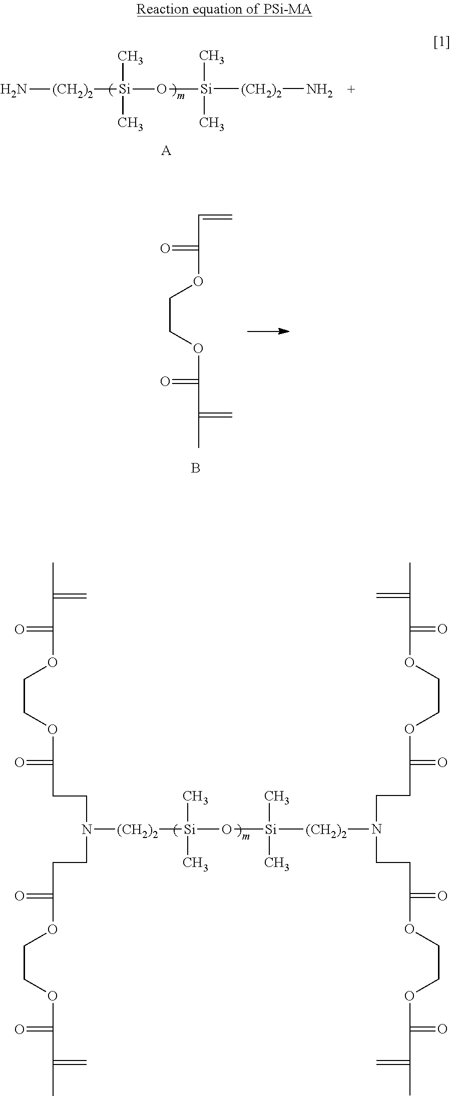

wherein B is glycol methacrylate, is of an asymmetric diene structure, self-made, and has controllability for Michael addition reaction; FIG. 1 is a nuclear magnetic map of glycol methacrylate, protons of the structure are in one-to-one correspondence to nuclear magnetic signal peaks, and the integral ratio conforms to the proton ratio, indicating that it is a target reactant.

A is amino-terminated silicone oil, namely, amino-terminated polymethoxy siloxane, with a structure as shown in formula [1], self-made; FIG. 2 is a nuclear magnetic map of amino-terminated silicone oil in embodiment 1, the structure is in one-to-one correspondence to nuclear magnetic proton peaks, and via integral computation, m=15, molecular weight being 1200.

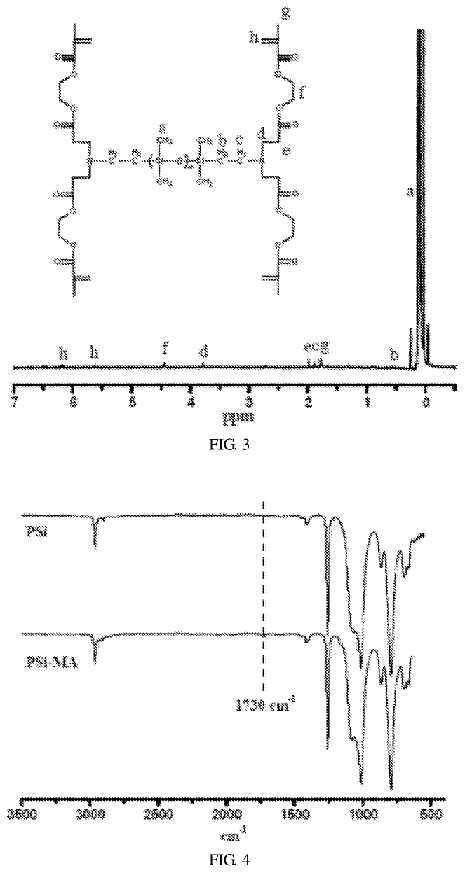

Respectively adding amino silicone oil (12.00 g, 0.01 mol) and solvent tetrahydrofuran (100 mL) to a 250 mL three-neck flask with a constant-pressure base solution funnel and a magnetic stirrer. Dripping an acrylate ethylene glycol methacrylate (7.36 g, 0.04 mol)-tetrahydrofuran solution (50 mL) to a reaction solution while stirring at normal temperature, lasting for 30 min, continuing to react for 5 h, and performing reduced pressure distillation after reaction is ended to obtain a solvent, so as to prepare a polymethyl siloxane material (PSi-MA) containing an acrylate-terminated structure. FIG. 3 is a nuclear magnetic map of PSi-MA obtained in formula [1], it is analyzed from a nuclear magnetic signal that the structure of PSi-MA is in one-to-one correspondence to nuclear magnetic proton peaks, the integral ratio is identical, and it is obtained by nuclear magnetic integral computation that the grafting rate of methacrylate reaches 97%, and molecular weight is 2000. Meanwhile, FIG. 4 is an infrared comparison diagram of amino-terminated silicone oil and PSi-MA, and it is found by comparison that PSi-MA contains 1730 cm⁻¹ of vibration peak of ester, and an acrylate ethylene glycol methacrylate structure is linked to an end group of polymethyl siloxane, indicating that PSi-MA is successfully prepared, with mark number of PSi-MA01, extra adding of excessive acrylate ethylene glycol methacrylate is not needed, side reaction such as cross-linking does not occur in the process, moreover, adding of catalyst is not needed, and propionate polymethyl siloxane is prepared simply, mildly and efficiently at room temperature.

### Embodiment 2

Synthesis of a polymethyl siloxane material (PSi-MA) containing an acrylate-terminated structure. A synthesis reaction formula is the same as that in [1].

The difference from embodiment 1 is that the molecular weight of amino-terminated silicone oil in formula [1] is 2300, m=30.

Under the circumstance of not changing other conditions of embodiment 1, during preparation, masses of amino silicone oil and glycol methacrylate are respectively: 11.5 g and 3.68 g, the use amount of the solvent is unchanged, tetrahydrofuran can be replaced with ethyl acetate, methylbenzene, dimethylbenzene, butanone and so on, the operation process is unchanged, and it is verified by the nuclear magnetic map and infrared characterization that PSi-MA is successfully prepared, molecular weight being 3000, and grafting rate of methacrylate reaching 95%. Mark number is PSi-MA02.

### Embodiment 3

Synthesis of a polymethyl siloxane material (PSi-MA) having a side group containing the methacrylate structure. A synthesis reaction formula is the same as that in [1].

The difference from embodiment 1 is that the molecular weight of amino-terminated silicone oil in formula [1] is 4500, m=60.

Under the circumstance of not changing other conditions of embodiment 1, masses of amino silicone oil and glycol methacrylate during preparation are respectively: 11.25 g and 1.84 g, the use amount of the solvent is unchanged, tetrahydrofuran can be replaced with ethyl acetate, methylbenzene, dimethylbenzene, butanone and so on, the operation process is unchanged, and it is verified by the nuclear magnetic map and infrared characterization that PSi-MA is successfully prepared, molecular weight being 5200, and grafting rate of methacrylate reaching 93%. Mark number is PSi-MA03.

### Embodiment 4

Synthesis of a polymethyl siloxane material (PSi-MA) containing an acrylate-terminated structure. A synthesis reaction formula is the same as that in [1].

The difference from embodiment 1 is that the molecular weight of amino silicone oil in formula [1] is 8900, m=120.

Under the circumstance of not changing other conditions of embodiment 1, masses of amino silicone oil and glycol methacrylate during preparation are respectively: 8.9 g and 0.74 g, the use amount of the solvent is unchanged, tetrahydrofuran can be replaced with ethyl acetate, methylbenzene, dimethylbenzene, butanone and so on, the operation process is unchanged, and it is verified by the nuclear magnetic map and infrared characterization that PSi-MA is successfully prepared, molecular weight being 9600, and grafting rate of methacrylate reaching 90%. Mark number is PSi-MA04.

### Embodiment 5

Ultraviolet curing reaction of a polymethyl siloxane material (PSi-MA) containing a methacrylate-terminated structure.

A compound photoinitiator: prepared from 1-hydroxycyclohexyl phenyl ketone (184) and 2-hydroxyl-4′-(2-hydroxylethoxy)-2-methylpropiophenone which are mixed according to a mass ratio of 1:1.

Mixing PSi-MA synthesized in reaction formula [1] with the foregoing compound photoinitiator according to a mass ratio of 100:1 to form a homogeneous phase, bubbling by adopting an inert gas, such as high-purity nitrogen (99.99%) or argon, to remove oxygen, performing roller coating to coat the solution to a PET film in a nitrogen atmosphere, and continuously performing ultraviolet irradiation for 5 seconds, to prepare a PSi-MA film.

Curing PSi-MA prepared in embodiments 1˜4 to form films, mark number being respectively PSi-MA01A, PSi-MA02A, PSi-MA03A, PSi-MA04A. Performing release performance test on the cured films.

TABLE 1
Release parameters of PSi-MA films

| | Contact | Release | Residual |
|---|---|---|---|
| Samples | angle/° | force/g/in | adhesion rate/% |
| Pure PET | 70 | — | — |
| PSi-MA01 | 88 | 11.5 | 91 |
| [symbol] | | | |
| PSi-MA02 | 89 | 9.2 | 95 |
| PSi-MA03 | 87 | 10.1 | 90 |
| PSi-MA04 | 87 | 9.2 | 89 |

[symbol]

indicates data missing or illegible when filed

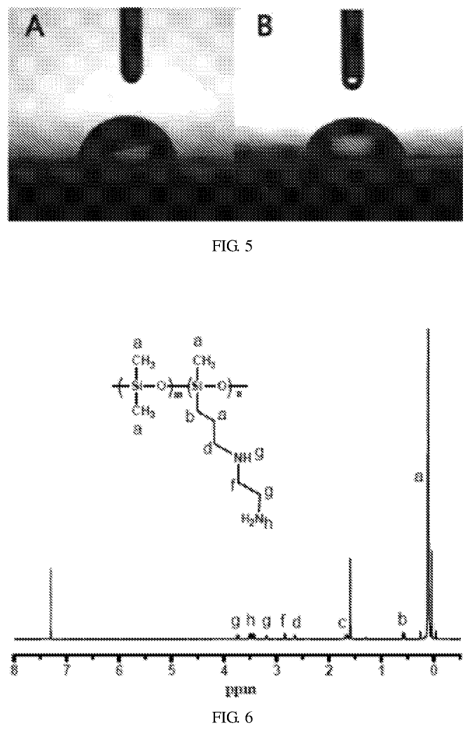

Table 1 is release performance results of PSi-MA films of different structures in a condition with a same compound photoinitiator, indicating that the residual adhesion rate of PSi-MA02A is the highest, which is up to 95%, meanwhile, release force is 9.2 g/in, a contact angle is promoted to 89° from 70° before modification, as shown in FIG. 5, polymer films of other mark numbers also meet the requirements, while the preparation effect of PSi-MA02 is the best, molecular weight is 3000, and the structure is the most reasonable, and thus are the optimal reaction conditions.

### Embodiment 6

Ultraviolet curing reaction of a polymethyl siloxane material (PSi-MA) containing an acrylate-terminated structure.

The difference from embodiment 5 is a compound photoinitiator: prepared from 2,4,6(trimethyl benzoyl)diphenylphosphine oxide and 4-dimethylamino-ethyl benzoate which are mixed according to a mass ratio of 1:1.

Under the circumstance of not changing other conditions of embodiment 5, curing PSi-MA prepared in embodiments 1-4 to form films, mark number being respectively PSi-MA01B, PSi-MA02B, PSi-MA03B, PSi-MA04B. Performing release performance test on the cured films.

TABLE 2
Release parameters of PSi-MA films

| | Contact | Release | Residual |
|---|---|---|---|
| Samples | angle/° | force/g/in | adhesion rate/% |
| Pure PET | 70 | — | — |
| PSi-MA01 | 88 | 11.0 | 90 |
| [symbol] | | | |
| PSi-MA02 | 88 | 9.1 | 94 |
| PSi-MA03 | 85 | 9.5 | 91 |
| PSi-MA04 | 87 | 10.0 | 89 |

[symbol]

indicates data missing or illegible when filed

Table 2 is release performance results of PSi-MA films of different structures in a condition with a same compound photoinitiator, indicating that the residual adhesion rate of PSi-MA02B is the highest, which is up to 94%, meanwhile, release force is 9.1 g/in, a contact angle is promoted to 88° from 70° before modification, polymer films of other mark numbers also meet the requirements, while the preparation effect of PSi-MA02 is the best, molecular weight is 3000, and the structure is the most reasonable, and thus are the optimal reaction conditions.

### Embodiment 7

The difference of ultraviolet curing reaction of a polymethyl siloxane material (PSi-MA) containing an acrylate-terminated structure from embodiment 5 is a compound photoinitiator: prepared from 2,4,6-ethyl trimethyl benzoyl phosphonate and 2-isopropylthioxanthone which are mixed according to a mass ratio of 1:1.

Under the circumstance of not changing other conditions of embodiment 5, curing PSi-MA prepared in embodiments 1˜4 to form films, mark number being respectively PSi-MA01C, PSi-MA02C, PSi-MA03C, PSi-MA04C. Performing release performance test on the cured films.

TABLE 3
Release parameters of PSi-MA films

| | Release | Residual |
|---|---|---|
| Samples | force/g/in | adhesion rate |
| Pure PET | — | — |
| PSi-MA01 | 10.7 | 90 |
| [symbol] | | |
| PSi-MA02 | 9.6 | 95 |
| PSi-MA03 | 10.0 | 88 |
| PSi-MA04 | 12.2 | 86 |

[symbol]

indicates data missing or illegible when filed

Table 3 is release performance results of PSi-MA films of different structures in a condition with a same compound photoinitiator, indicating that the residual adhesion rate of PSi-MA02C is the highest, which is up to 95%, meanwhile, release force is 9.6 g/in, a contact angle is promoted to 88° from 70° before modification, polymer films of other mark numbers also meet the requirements, while the preparation effect of PSi-MA02 is the best, molecular weight is 3000, and the structure is the most reasonable, and thus are the optimal reaction conditions.

### Embodiment 8

Under the circumstance of not changing other conditions of embodiment 5, preparing a PSi-MA film by adopting PSi-MA and a compound photoinitiator according to a mass ratio of 200:1, and testing release performances.

TABLE 4
Release parameters of PSi-MA films

| | Contact | Release | Residual |
|---|---|---|---|
| Samples | angle/° | force/g/in | adhesion rate/% |
| Pure PET | 70 | — | — |
| PSi-MA01 | 86 | 8.5 | 87 |
| [symbol] | | | |
| PSi-MA02 | 87 | 10.2 | 90 |
| PSi-MA03 | 84 | 10.3 | 82 |
| PSi-MA04 | 85 | 9.7 | 85 |

[symbol]

indicates data missing or illegible when filed

Table 4 is release performance results of PSi-MA films of different structures in a condition with a same compound photoinitiator, indicating that the residual adhesion rate of PSi-MA02D is the highest, which is up to 90%, meanwhile, release force is 10.2 g/in, a contact angle is promoted to 87° from 70° before modification, and in comparison with embodiment 5, the residual adhesion rate of PSi-MA02D is lower than that of PSi-MA02A, therefore, the optimum use amount of the initiator is greater than the mass of PSi-MA by 1%.

It is known from embodiment 5 and embodiments 6, 7 that PSi-MA can be effectively initiated by using all the compound photoinitiators described in the present invention, without obvious difference in effect, indicating that PSi-MA has better compatibility to initiators, is insensitive to the structure of initiators, and thus is favorable for popularization and application; the preparation effect of PSi-MA02 is the best, molecular weight is 3000, the structure is the most reasonable, and embodiment 1 is the optimal reaction condition. Moreover, by comparing embodiment 5 with embodiment 8, based on consideration on cost, the optimum use amount of the initiator is greater than the mass of PSi-MA by 1%.

The followings are embodiments of reaction formula [2]:

### Embodiment 9

Synthesis of a polymethyl siloxane material (PSi-MA) having a side group containing the methacrylate structure. A synthesis reaction formula [2] being:

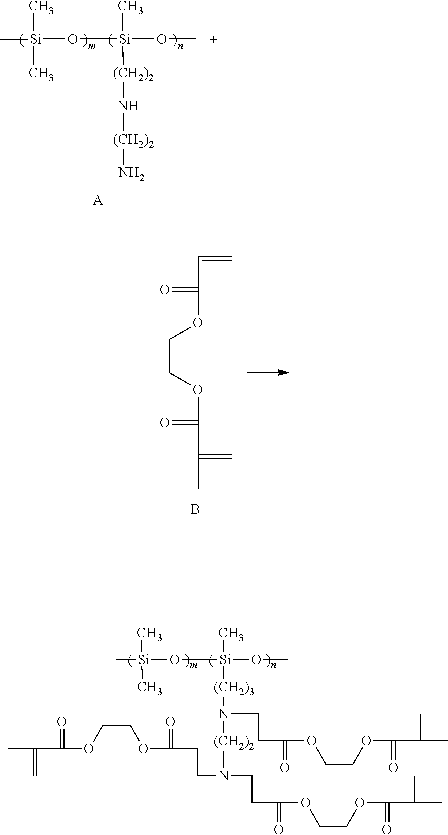

wherein B is glycol methacrylate, is of an asymmetric diene structure, self-made, and has controllability for Michael addition reaction,

FIG. 1 is a nuclear magnetic map of glycol methacrylate, protons of the structure are in one-to-one correspondence to nuclear magnetic signal peaks, and the integral ratio conforms to the proton ratio, indicating that it is a target reactant.

A is amino silicone oil, namely, amino polymethoxy siloxane, with a structure as shown in formula [2], molecular weight being 8200, self-made; FIG. 6 is a nuclear magnetic map of amino silicone oil, the structure is in one-to-one correspondence to nuclear magnetic proton peaks, and via integral computation, m=100, n=5, and the molar content of amino-containing methylsiloxane is 4.8%.

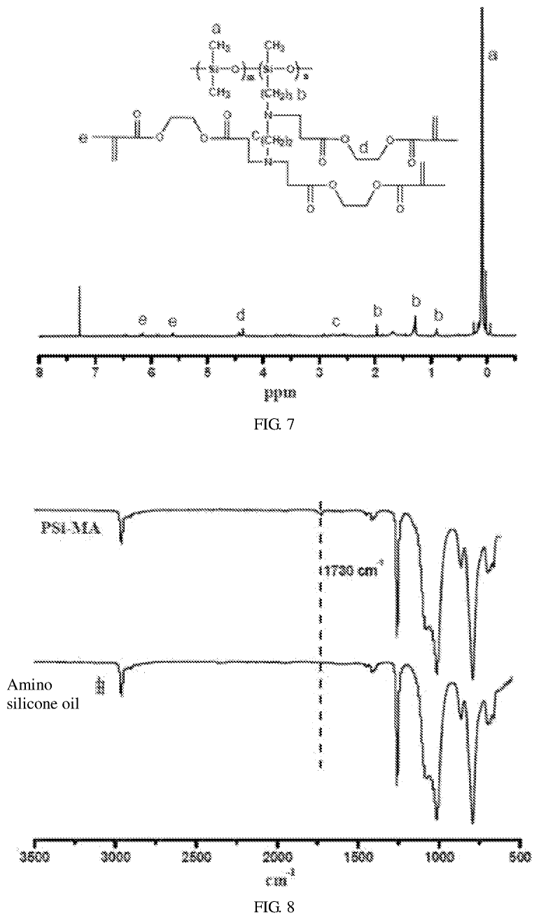

Respectively adding amino silicone oil (10.00 g, 0.00125 mol) and solvent tetrahydrofuran (100 mL) to a 250 mL three-neck flask with a constant-pressure base solution funnel and a magnetic stirrer. Dripping an acrylate ethylene glycol methacrylate (3.50 g, 0.019 mol)-tetrahydrofuran solution (50 mL) to a reaction solution while stirring at normal temperature, lasting for 30 min, continuing to react for 5 h, and performing reduced pressure distillation after reaction is ended to obtain a solvent, so as to prepare a polymethyl siloxane material (PSi-MA) having a side group containing a methacrylate structure. FIG. 7 is a nuclear magnetic map of PSi-MA obtained in formula [2], it is analyzed from a nuclear magnetic signal that the structure of PSi-MA is in one-to-one correspondence to nuclear magnetic proton peaks, the integral ratio is identical, and it is obtained by nuclear magnetic integral computation that the grafting rate of methacrylate reaches 97%. Meanwhile, FIG. 8 is an infrared comparison diagram of amino silicone oil and PSi-MA in reaction formula [2], and it is found by comparison that PSi-MA contains 1730 cm⁻¹ of vibration peak of ester, and an acrylate ethylene glycol methacrylate structure is linked to a side chain of polymethyl siloxane, indicating that PSi-MA is successfully prepared, with mark number of PSi-MA01, extra adding of excessive acrylate ethylene glycol methacrylate is not needed, side reaction such as cross-linking does not occur in the process, adding of catalyst is not needed, and propionate polymethyl siloxane is prepared simply, mildly and efficiently at room temperature.

### Embodiment 10

Synthesis of a polymethyl siloxane material (PSi-MA) having a side group containing the methacrylate structure. A synthesis reaction formula is the same as that in embodiment 9.

The difference from embodiment 9 is that the molecular weight of amino silicone oil is 8200, m=90, n=10, and the molar content of amino-containing methylsiloxane is 10%. Under the circumstance of not changing other conditions of embodiment 9, parts by weight of amino silicone oil and glycol methacrylate during preparation are respectively: 10 parts and 7 parts, the use amount of the solvent is unchanged, tetrahydrofuran can be replaced with ethyl acetate, methylbenzene, dimethylbenzene, butanone and so on, the operation process is unchanged, and it is verified by the nuclear magnetic map and infrared characterization that PSi-MA is successfully prepared, grafting rate of methacrylate reaching 95%. Mark number: PSi-MA02.

### Embodiment 11

Synthesis of a polymethyl siloxane material (PSi-MA) having a side group containing the methacrylate structure. A synthesis reaction formula is the same as that in embodiment 9.

The difference from embodiment 9 is that the molecular weight of amino silicone oil is 8200, m=104, n=3, and the molar content of amino-containing methylsiloxane is 2.8%.

Under the circumstance of not changing other conditions of embodiment 9, parts by weight of amino silicone oil and glycol methacrylate during preparation are respectively: 10 parts and 2.5 parts, the use amount of the solvent is unchanged, tetrahydrofuran can be replaced with ethyl acetate, methylbenzene, dimethylbenzene, butanone and so on, the operation process is unchanged, and it is verified by the nuclear magnetic map and infrared characterization that PSi-MA is successfully prepared, grafting rate of methacrylate reaching 95%. Mark number: PSi-MA03.

### Embodiment 12

Synthesis of a polymethyl siloxane material (PSi-MA) having a side group containing the methacrylate structure. A synthesis reaction formula is the same as that in embodiment 9.

The difference from embodiment 9 is that the molecular weight of amino silicone oil is 4100, m=50, n=3, and the molar content of amino-containing methylsiloxane is 5.7%.

Under the circumstance of not changing other conditions of embodiment 9, parts by weight of amino silicone oil and glycol methacrylate during preparation are respectively: 10 parts and 3.5 parts, the use amount of the solvent is unchanged, tetrahydrofuran can be replaced with ethyl acetate, methylbenzene, dimethylbenzene, butanone and so on, the operation process is unchanged, and it is verified by the nuclear magnetic map and infrared characterization that PSi-MA is successfully prepared, grafting rate of methacrylate reaching 92%. Mark number: PSi-MA04.

### Embodiment 13

Ultraviolet curing reaction of a polymethyl siloxane material (PSi-MA) containing a methacrylate structure.

A compound photoinitiator: prepared from 1-hydroxycyclohexyl phenyl ketone (184) and 2-hydroxyl-4′-(2-hydroxylethoxy)-2-methylpropiophenone which are mixed according to a mass ratio of 1:1.

Mixing PSi-MA of embodiment 9 with the foregoing compound photoinitiator according to a mass ratio of 100:1 to form a homogeneous phase, bubbling by adopting an inert gas, such as high-purity nitrogen (99.99%) or argon, to remove oxygen, performing roller coating to coat the solution to a PET film in a nitrogen atmosphere, and continuously performing ultraviolet irradiation for 5 seconds, to prepare a PSi-MA film.

Curing PSi-MA prepared in embodiments 1-4 to form films, mark number being respectively PSi-MA01A, PSi-MA02A, PSi-MA03A, PSi-MA04A. Performing release performance test on the cured films.

TABLE 5
Release parameters of PSi-MA films

| | Contact | Release | Residual |
|---|---|---|---|
| Samples | angle/° | force/g/in | adhesion rate/% |
| Pure PET | 70 | — | — |
| PSi-MA01 | 85 | 9.5 | 95 |
| [symbol] | | | |
| PSi-MA02 | 84 | 12.2 | 88 |
| PSi-MA03 | 82 | 10.1 | 90 |
| PSi-MA04 | 83 | 9.2 | 89 |

[symbol]

indicates data missing or illegible when filed

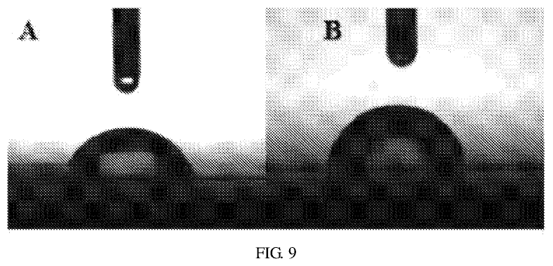

Table 5 is release performance results of PSi-MA films of different structures in a condition with a same compound photoinitiator, indicating that the residual adhesion rate of PSi-MA01A is the highest, which is up to 95%, meanwhile, release force is 9.5 g/in, a contact angle is promoted to 85° from 70° before modification, as shown in FIG. 9, polymer films of other mark numbers also meet the requirements, while the preparation effect of PSi-MA01 is the best, and the structure is the most reasonable, and thus are the optimal reaction conditions.

### Embodiment 14

Ultraviolet curing reaction of a polymethyl siloxane material (PSi-MA) containing a methacrylate structure.

The difference from embodiment 13 is a compound photoinitiator: prepared from 2,4,6(trimethyl benzoyl)diphenylphosphine oxide and 4-dimethylamino-ethyl benzoate which are mixed according to a mass ratio of 1:1.

Under the circumstance of not changing other conditions of embodiment 13, curing PSi-MA prepared in embodiments 9-12 to form films, mark number being respectively PSi-MA01B, PSi-MA02B, PSi-MA03B, PSi-MA04B. Performing release performance test on the cured films.

TABLE 6
Release parameters of PSi-MA films

| | Contact | Release | Residual |
|---|---|---|---|
| Samples | angle/° | force/g/in | adhesion rate/% |
| Pure PET | 70 | — | — |
| PSi-MA01 | 86 | 9.1 | 94 |
| [symbol] | | | |
| PSi-MA02 | 82 | 11.0 | 87 |
| PSi-MA03 | 84 | 10.0 | 90 |
| PSi-MA04 | 84 | 9.3 | 88 |

[symbol]

indicates data missing or illegible when filed

Table 6 is release performance results of PSi-MA films of different structures in a condition with a same compound photoinitiator, indicating that the residual adhesion rate of PSi-MA01B is the highest, which is up to 94%, meanwhile, release force is 9.1 g/in, a contact angle is promoted to 86° from 70° before modification, polymer films of other mark numbers also meet the requirements, while the preparation effect of PSi-MA01 is the best, and the structure is the most reasonable, and thus are the optimal reaction conditions.

### Embodiment 15

Ultraviolet curing reaction of a polymethyl siloxane material (PSi-MA) containing a methacrylate structure.

The difference from embodiment 13 is a compound photoinitiator: prepared from 2,4,6-ethyl trimethyl benzoyl phosphonate and 2-isopropylthioxanthone which are mixed according to a mass ratio of 1:1.

Under the circumstance of not changing other conditions of embodiment 13, curing PSi-MA prepared in embodiments 9-12 to form films, mark number being respectively PSi-MA01C, PSi-MA02C, PSi-MA03C, PSi-MA04C. Performing release performance test on the cured films.

TABLE 7
Release parameters of PSi-MA films

| | Contact | Release | Residual |
|---|---|---|---|
| Samples | angle/° | force/g/in | adhesion rate/% |
| Pure PET | 70 | — | — |
| PSi-MA01 | 87 | 9.7 | 97 |
| [symbol] | | | |
| PSi-MA02 | 84 | 12.0 | 86 |
| PSi-MA03 | 82 | 11.0 | 88 |
| PSi-MA04 | 81 | 10.2 | 85 |

[symbol]

indicates data missing or illegible when filed

Table 7 is release performance results of PSi-MA films of different structures in a condition with a same compound photoinitiator, indicating that the residual adhesion rate of PSi-MA01C is the highest, which is up to 97%, meanwhile, release force is 9.7 g/in, a contact angle is promoted to 87° from 70° before modification, polymer films of other mark numbers also meet the requirements, while the preparation effect of PSi-MA01 is the best, and the structure is the most reasonable, and thus are the optimal reaction conditions.

### Embodiment 16

Under the circumstance of not changing other conditions of embodiment 13, preparing a PSi-MA film by adopting PSi-MA and a compound photoinitiator according to a mass ratio of 200:1, and testing release performances.

TABLE 8
Release parameters of PSi-MA films

| | Contact | Release | Residual |
|---|---|---|---|
| Samples | angle/° | force/g/in | adhesion rate/% |
| Pure PET | 70 | — | — |
| PSi-MA01 | 86 | 7.5 | 90 |
| [symbol] | | | |
| PSi-MA02 | 85 | 12.2 | 85 |
| PSi-MA03 | 81 | 10.1 | 84 |
| PSi-MA04 | 82 | 9.2 | 83 |

[symbol]

indicates data missing or illegible when filed

Table 8 is release performance results of PSi-MA films of different structures in a condition with a same compound photoinitiator, indicating that the residual adhesion rate of PSi-MA01D is the highest, which is up to 90%, meanwhile, release force is 7.5 g/in, a contact angle is promoted to 86° from 70° before modification, and in comparison with embodiment 9, the residual adhesion rate of PSi-MA01D is lower than that of PSi-MA01A, therefore, the optimum use amount of the initiator is greater than the mass of PSi-MA by 1%.

It is known from embodiment 13 and embodiments 14, 15 that PSi-MA can be effectively initiated by using all the compound photoinitiators described in the present invention, without obvious difference in effect, indicating that PSi-MA has better compatibility to initiators, is insensitive to the structure of initiators, and thus is favorable for popularization and application; the preparation effect of PSi-MA01 is the best, the structure is the most reasonable, and embodiment 9 is the optimal reaction conditions. Moreover, by comparing embodiment 13 with embodiment 16, based on consideration on cost, the optimum use amount of the initiator is greater than the mass of PSi-MA by 1%.

The foregoing descriptions are merely preferred embodiments of the present invention but are not intended to limit the present invention, and a person skilled in the art may still make modifications on technical schemes recorded in the foregoing embodiments, or perform equivalent substitution on partial technical features thereof. Any modification, equivalent substitution and improvement made within the spirit and principle of the present invention should fall within the protection scope of the present invention.

What is claimed is:

1. A method for preparing an ultraviolet (UV) curing polymethyl siloxane containing an acrylate structure, comprising: performing a Michael addition reaction with an amino silicone oil by means of an asymmetric diene-structured acrylate ethylene glycol methacrylate, the grafting rate of methacrylate reaching more than 95%;
a reaction formula of the polymethyl siloxane being [1]: 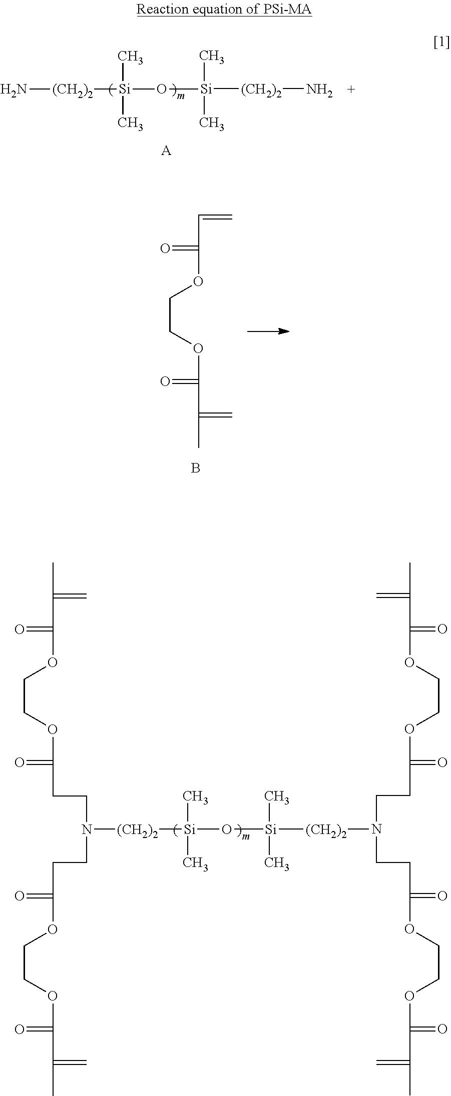
or a reaction formula being [2]:

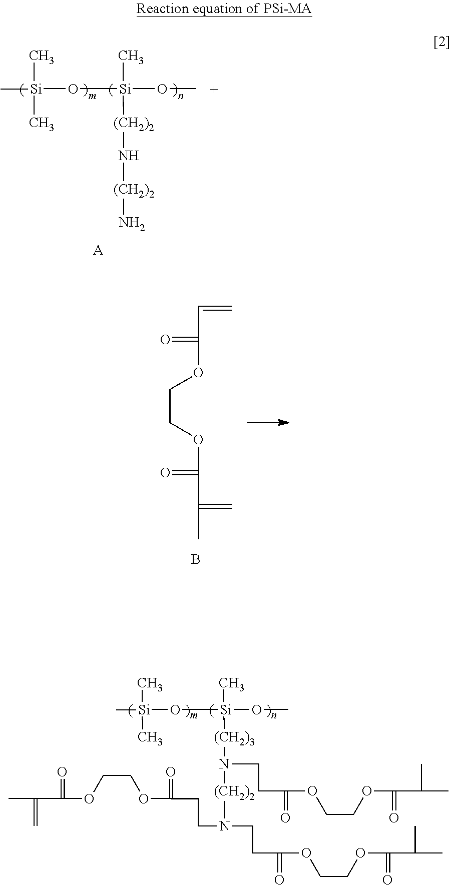

2. The method for preparing an ultraviolet (UV) curing polymethyl siloxane containing an acrylate structure according to claim 1, wherein in the formula [1], m in the structure of the raw material A, amino-terminated silicone oil, is any integer, and may be set as m=15˜200, molecular weight being 1000˜15000; raw material B is of an asymmetric diene structure, acrylate ethylene glycol methacrylate, and the use amount of the raw material B is hydrogen quantity in amino of amino silicone oil of equal molar weight.

3. The method for preparing an ultraviolet (UV) curing polymethyl siloxane containing an acrylate structure according to claim 1, wherein in the formula [2], m and n in the structure of raw material A, amino-terminated silicone oil, may be any integer, and may be set as m=20˜150, n=1˜20, m:n=1:1˜50:1, molecular weight being 1000˜20000; raw material B is acrylate ethylene glycol methacrylate which is of an asymmetric diene structure, and the use amount of the raw material B is hydrogen quantity in amino of amino silicone oil of equal molar weight.

4. The method for preparing an ultraviolet (UV) curing polymethyl siloxane containing an acrylate structure according to claim 1, the ultraviolet (UV) curing polymethyl siloxane containing an acrylate structure being prepared by the following steps:
(1) respectively adding amino silicone oil and solvent tetrahydrofuran to a reactor with a constant-pressure base solution funnel and a magnetic stirrer, dripping an acrylate ethylene glycol methacrylate-tetrahydrofuran solution to a reaction solution while stirring at normal temperature, lasting for 30 min, continuing to react for 5 h, and performing reduced pressure distillation after reaction is ended to obtain a solvent, so as to prepare polymethyl siloxane (PSi-MA) containing an acrylate structure; and
(2) mixing PSi-MA with a compound photoinitiator to form a homogeneous phase, bubbling by selecting an inert gas to remove oxygen, performing roller coating to coat the solution to a PET film, and continuously performing ultraviolet irradiation for 1˜5 seconds, to prepare a PSi-MA film.

5. The method for preparing an ultraviolet (UV) curing polymethyl siloxane containing an acrylate structure according to claim 4, wherein the reaction temperature in step (1) is 25° C. room temperature; and reaction time is 5 hours, PSi-MA is obtained by reduced pressure rotary evaporation, a solvent is recyclable, and the whole technological process is simple and controllable.

6. The method for preparing an ultraviolet (UV) curing polymethyl siloxane containing an acrylate structure according to claim 4, wherein the photoinitiator in step (2) is compounded by two or more than two photoinitiators out of 1-hydroxycyclohexyl phenyl ketone (184), 2-hydroxyl-4′-(2-hydroxylethoxy)-2-methylpropiophenone, 2,4,6(trimethyl benzoyl)diphenylphosphine oxide, 2,4,6-ethyl trimethyl benzoyl phosphonate, 2-isopropylthioxanthone and 4-dimethylamino-ethyl benzoate.

7. The method for preparing an ultraviolet (UV) curing polymethyl siloxane containing an acrylate structure according to claim 4, wherein the use amount of the compound photoinitiator is the mass content of PSi-MA, which is 0.1%-2%, PSi-MA is mixed with the compound photoinitiator to form a homogeneous phase, and inert gas such as high-purity nitrogen (99.99%) or argon is selected as a protective gas to perform ultraviolet irradiation for 1˜5 seconds, to prepare a PSi-MA film.
